(19) United States
(12) Patent Application Publication
(10) Pub. No.: US 2017/0322906 A1
(43) Pub. Date: Nov. 9, 2017

(54) Processor with In-Package Look-Up Table

(71) Applicant: ChengDu HaiCun IP Technology LLC, ChengDu (CN)

(72) Inventor: Guobiao ZHANG, Corvallis, OR (US)

(73) Assignee: ChengDu HaiCun IP Technology LLC, ChengDu (CN)

(21) Appl. No.: 15/587,359

(22) Filed: May 4, 2017

(30) Foreign Application Priority Data
May 4, 2016 (CN) 201610294287.2
May 2, 2017 (CN) 201710302436.X

(51) Int. Cl. G06F 15/82; G06F 7/50; G06F 7/523; G06F 15/78

(52) U.S. Cl. CPC G06F 15/82; G06F 15/7807; G06F 7/50; G06F 7/523

(57) ABSTRACT

The present invention discloses a processor for computing a mathematical function. The processor comprises a memory die and a logic die. The memory die comprises a look-up table circuit (LUT) for storing data related to the mathematical function. The logic die comprises an arithmetic logic circuit (ALC) for performing arithmetic operations on the function-related data. The memory die and the logic die are located in a same package.

### CROSS-REFERENCE TO RELATED APPLICATIONS

This application claims priority from Chinese Patent Application 201610294287.2, filed on May 4, 2016; Chinese Patent Application 201710302436.X, filed on May 2, 2017, in the State Intellectual Property Office of the People's Republic of China (CN), the disclosure of which are incorporated herein by references in their entireties.

### BACKGROUND

### 1. Technical Field of the Invention

The present invention relates to the field of integrated circuit, and more particularly to processors.

### 2. Prior Art

Conventional processors use logic-based computation (LBC), which carries out computation primarily with logic circuits (e.g. XOR circuit). Logic circuits are suitable for arithmetic operations (i.e. addition, subtraction and multiplication), but not for non-arithmetic functions (e.g. elementary functions, special functions). Non-arithmetic functions are computationally hard. Rapid and efficient realization of the non-arithmetic functions has been a major challenge.

For the conventional processors, only few basic non-arithmetic functions (e.g. basic algebraic functions and basic transcendental functions) are implemented by hardware and they are referred to as built-in functions. These built-in functions are realized by a combination of arithmetic operations and look-up tables (LUT). For example, U.S. Pat. No. 5,954,787 issued to Eun on Sep. 21, 1999 taught a method for generating sine/cosine functions using LUTs; U.S. Pat. No. 9,207,910 issued to Azadet et al. on Dec. 8, 2015 taught a method for calculating a power function using LUTs.

Realization of built-in functions is further illustrated in FIG. 1A. A conventional processor 00X generally comprises a logic circuit 100X and a memory circuit 200X. The logic circuit 100X comprises an arithmetic logic unit (ALU) for performing arithmetic operations, whereas the memory circuit 200X comprises a look-up table circuit (LUT) for storing data related to the built-in function. To achieve a desired precision, the built-in function is approximated to a polynomial of a sufficiently high order. The LUT 200X stores the coefficients of the polynomial; and the ALU 100X calculates the polynomial. Because the ALU 100X and the LUT 200X are formed side-by-side on a semiconductor substrate 00S, this type of horizontal integration is referred to as two-dimensional (2-D) integration.

The 2-D integration puts stringent requirements on the manufacturing process. As is well known in the art, the memory transistors in the LUT 200X are vastly different from the logic transistors in the ALC 100X. The memory transistors have stringent requirements on leakage current, while the logic transistors have stringent requirements on drive current. To form high-performance memory transistors and high-performance logic transistors on the same surface of the semiconductor substrate 00S at the same time is a challenge.

The 2-D integration also limits computational density and computational complexity. Computation has been developed towards higher computational density and greater computational complexity. The computational density, i.e. the computational power (e.g. the number of floating-point operations per second) per die area, is a figure of merit for parallel computation. The computational complexity, i.e. the total number of built-in functions supported by a processor, is a figure of merit for scientific computation. For the 2-D integration, inclusion of the LUT 200X increases the die size of the conventional processor 00X and lowers its computational density. This has an adverse effect on parallel computation. Moreover, because the ALU 100X, as the primary component of the conventional processor 00X, occupies a large die area, the LUT 200X, occupying only a small die area, supports few built-in functions. FIG. 1B lists all built-in transcendental functions supported by an Intel Itanium (IA-64) processor (referring to Harrison et al. “The Computation of Transcendental Functions on the IA-64 Architecture”, Intel Technical Journal, Q4 1999, hereinafter Harrison). The IA-64 processor supports a total of 7 built-in transcendental functions, each using a relatively small LUT (from 0 to 24 kb) in conjunction with a relatively high-order Taylor series (from 5 to 22).

### OBJECTS AND ADVANTAGES

It is a principle object of the present invention to drive a paradigm shift for scientific computation.

It is a further object of the present invention to provide a processor with improved computational complexity.

It is a further object of the present invention to provide a processor with improved computational density.

It is a further object of the present invention to provide a processor with a large set of built-in functions.

It is a further object of the present invention to compute mathematical functions rapidly.

It is a further object of the present invention to compute mathematical functions efficiently.

It is a further object of the present invention to reconcile the manufacturing processes of the memory circuits and the logic circuits.

In accordance with these and other objects of the present invention, the present invention discloses a processor with an in-package look-up table (IP-LUT).

### SUMMARY OF THE INVENTION

The present invention discloses a processor with an in-package look-up table (IP-LUT) (i.e. IP-LUT processor). The IP-LUT processor comprises a logic die and a memory die. The logic die comprises at least an arithmetic logic circuit (ALC) and is referred to as an ALC die, whereas the memory die comprises at least a look-up table circuit (LUT) and is referred to as an LUT die. The ALC die and LUT die are located in a same package and they are communicatively coupled by a plurality of inter-die connections. Located in the same package as the ALC, the LUT is referred to as in-package LUT (IP-LUT). The IP-LUT stores data related to a mathematical function, while the ALC performs arithmetic operations on the function-related data.

The IP-LUT processor uses memory-based computation (MBC), which carries out computation primarily with the LUT. Compared with the LUT used by the conventional processor, the IP-LUT used by the IP-LUT processor has a much larger capacity. Although arithmetic operations are still performed, the MBC only needs to calculate a polynomial to a lower order because it uses a larger IP-LUT as a starting point for computation. For the MBC, the fraction of computation done by the IP-LUT could be more than the ALC.

Because the ALC die and the LUT die are located in a same package, this type of vertical integration is referred to as 2.5-D integration. The 2.5-D integration has a profound effect on the computational density and computational complexity. For the conventional 2-D integration, the footprint of a conventional processor 00X is roughly equal to the sum of those of the ALU 100X and the LUT 200X. On the other hand, because the 2.5-D integration moves the LUT from aside to above, the IP-LUT processor becomes smaller and computationally more powerful. In addition, the total LUT capacity of the conventional processor 00X is less than 100 kb, whereas the total IP-LUT capacity for the IP-LUT processor could reach 100 Gb. Consequently, a single IP-LUT processor could support as many as 10,000 built-in functions (including various types of complex mathematical functions), far more than the conventional processor 00X. Furthermore, because the ALC die and the LUT die are separate dice, the logic transistors in the ALC die and the memory transistors in the LUT die are formed on separate semiconductor substrates. Consequently, their manufacturing processes can be individually optimized.

Accordingly, the present invention discloses a processor for computing a mathematical function, comprising: a memory die comprising a look-up table circuit (LUT) for storing data related to said mathematical function; a logic die comprising an arithmetic logic circuit (ALC) for performing arithmetic operations on said data; a plurality of inter-die connections for communicatively coupling said memory die and said logic die; wherein said memory die and said logic die are located in a same package.

### BRIEF DESCRIPTION OF THE DRAWINGS

FIG. 1A is a schematic view of a conventional processor (prior art); FIG. 1B lists all transcendental functions supported by an Intel Itanium (IA-64) processor (prior art);

FIG. 2A is a simplified block diagram of a preferred IP-LUT processor; FIG. 2B is a perspective view of the preferred IP-LUT processor;

FIGS. 3A-3C are the cross-sectional views of three preferred IP-LUT processors;

FIG. 4A is a simplified block diagram of a preferred IP-LUT processor realizing a mathematical function; FIG. 4B is a block diagram of a preferred IP-LUT processor realizing a single-precision mathematical function; FIG. 4C lists the LUT size and Taylor series required to realize mathematical functions with different precisions;

FIG. 5 is a block diagram of a preferred IP-LUT processor realizing a composite function.

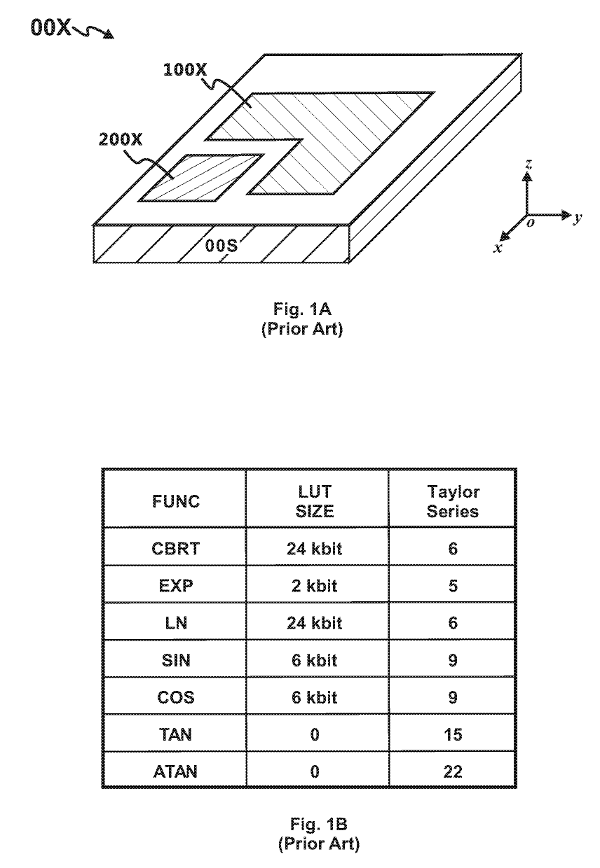

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments. The symbol “/” means a relationship of “and” or “or”. Throughout the present invention, both “look-up table” and “look-up table circuit” are abbreviated to LUT. Based on context, the LUT may refer to a look-up table or a look-up table circuit.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

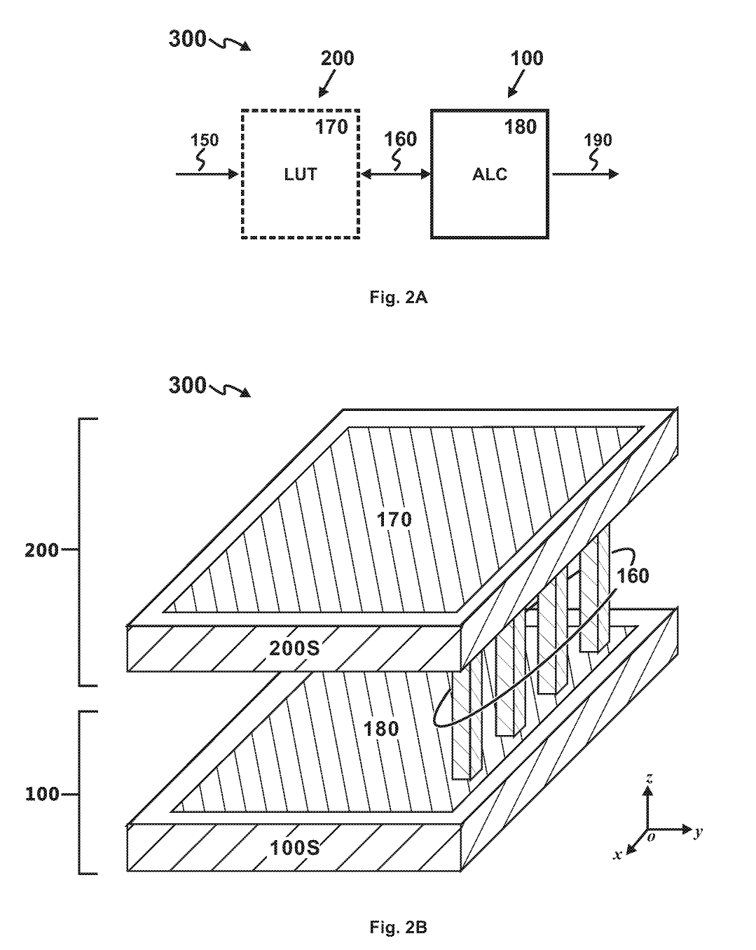

Referring now to FIG. 2A-2B, a preferred IP-LUT processor 300 is disclosed. The IP-LUT processor 300 has one or more inputs 150, and one or more outputs 190. The IP-LUT processor 300 further comprises a logic die 100 and a memory die 200. The logic die 100 is formed on a first semiconductor substrate 1005 and comprises at least an arithmetic logic circuit (ALC) 180. Accordingly, the logic die 100 is also referred to as an ALC die. On the other hand, the memory die 200 is formed on a second semiconductor substrate 200S and comprises at least a look-up table circuit (LUT). Accordingly, the memory die 200 is also referred to as an LUT die. The ALC die and LUT die are located in a same package and they are communicatively coupled by a plurality of inter-die connections 160. Located in the same package as the ALC 180, the LUT 170 is referred to as in-package LUT (IP-LUT). The IP-LUT 170 stores data related to a mathematical function, while the ALC 180 performs arithmetic operations on the function-related data. In this preferred embodiment, the LUT die 200 is stacked on the ALC die 100, with the IP-LUT 170 and the ALC 180 at least partially overlapping. Because they are formed on separate dice, the IP-LUT 170 is represented by dashed lines and the ALC 180 is represented by solid lines throughout the present invention.

The IP-LUT 170 may use a RAM or a ROM. The RAM includes SRAM and DRAM. The ROM includes mask ROM, OTP, EPROM, EEPROM and flash memory. The flash memory can be categorized into NOR and NAND, and the NAND can be further categorized into horizontal NAND and vertical NAND. On the other hand, the ALC 180 may comprise an adder, a multiplier, and/or a multiply-accumulator (MAC). It may perform integer operation, fixed-point operation, or floating-point operation.

The IP-LUT processor 300 uses memory-based computation (MBC), which carries out computation primarily with the IP-LUT 170. Compared with the LUT 200X used by the conventional processor 00X, the IP-LUT 170 used by the IP-LUT processor 300 has a much larger capacity. Although arithmetic operations are still performed, the MBC only needs to calculate a polynomial to a lower order because it uses a larger IP-LUT 170 as a starting point for computation. For the MBC, the fraction of computation done by the IP-LUT 170 could be more than the ALC 180.

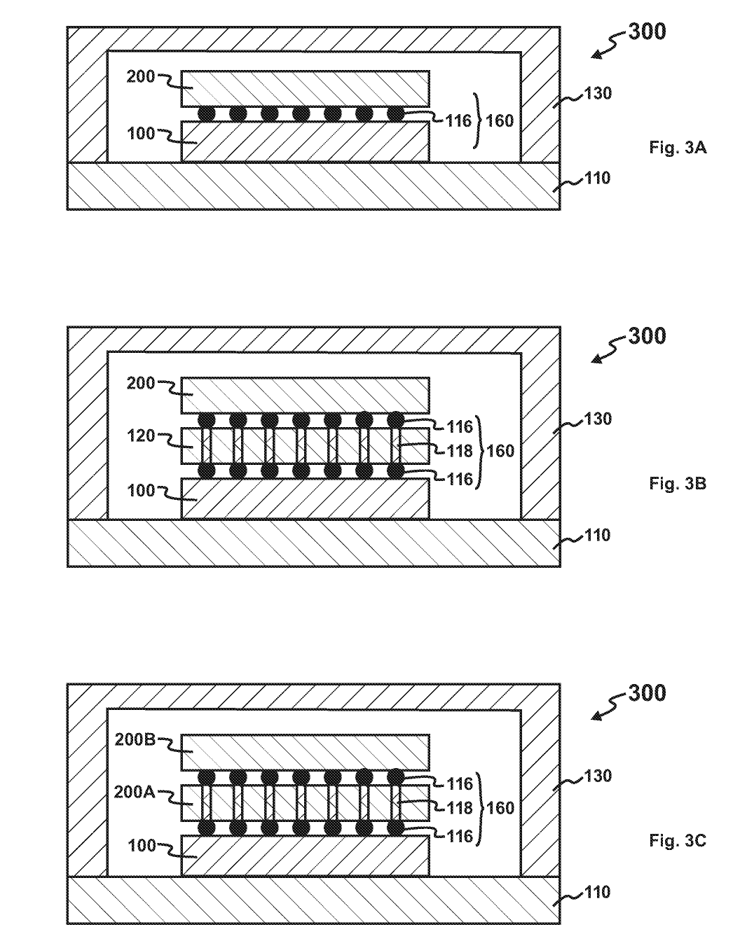

Referring now to FIGS. 3A-3C, the cross-sectional views of three preferred IP-LUT processors 300 are shown. These preferred embodiments are located in multi-chip packages (MCP). Among them, the IP-LUT processor 300 in FIG. 3A comprises two separate dice: an ALC die 100 and an LUT die 200. The dice 100, 200 are stacked on the package substrate 110 and located in a same package 130. Micro-bumps 116 act as the inter-die connections 160 and provide electrical coupling between the dice 100, 200. In this preferred embodiment, the LUT die 200 is stacked on the ALC die 100; the LUT die 200 is flipped and bonded face-to-face with the ALC die 100. Alternatively, the ALC die 100 may be stacked on the LUT die 200; either die does not have to be flipped.

The IP-LUT processor 300 in FIG. 3B comprises an ALC die 100, an interposer 120 and an LUT die 200. The interposer 120 comprise a plurality of through-silicon vias (TSV) 118. The TSVs 118 provide electrical couplings between the ALC die 100 and the LUT die 200, offer more freedom in design and facilitate heat dissipation. In this preferred embodiment, the TSVs 118 and the micro-bumps 116 collectively form the inter-die connections 160.

The IP-LUT processor 300 in FIG. 3C comprises an ALC die 100, and at least two LUT dice 200A, 200B. These dice 100, 200A, 200B are separate dice and located in a same package 130. Among them, the LUT die 200B is stacked on the LUT die 200A, while the LUT die 200A is stacked on the ALC die 100. The dice 100, 200A, 200B are electrically coupled with the TSVs 118 and the micro-bumps 116. Apparently, the IP-LUT 170 in FIG. 3C has a large capacity than that in FIG. 3A. Similarly, the TSVs 118 and the micro-bumps 116 collectively form the inter-die connections 160.

Because the ALC die 100 and the LUT die 200 are located in a same package, this type of vertical integration is referred to as 2.5-D integration. The 2.5-D integration has a profound effect on the computational density and computational complexity. For the conventional 2-D integration, the footprint of a conventional processor 00X is roughly equal to the sum of those of the ALU 100X and the LUT 200X. On the other hand, because the 2.5-D integration moves the LUT from aside to above, the IP-LUT processor 300 becomes smaller and computationally more powerful. In addition, the total LUT capacity of the conventional processor 00X is less than 100 kb, whereas the total IP-LUT capacity for the IP-LUT processor 300 could reach 100 Gb. Consequently, a single IP-LUT processor 300 could support as many as 10,000 built-in functions (including various types of complex mathematical functions), far more than the conventional processor 00X. Moreover, the 2.5-D integration can improve the communication throughput between the IP-LUT 170 and the ALC 180. Because they are physically close and coupled by a large number of inter-die connections 160, the IP-LUT 170 and the ALC 180 have a larger communication throughput than the LUT 200X and the ALU 100X in the conventional processor 00X. Lastly, the 2.5-D integration benefits manufacturing process. Because the ALC die 100 and the LUT die 200 are separate dice, the logic transistors in the ALC die 100 and the memory transistors in the LUT die 200 are formed on separate semiconductor substrates. Consequently, their manufacturing processes can be individually optimized.

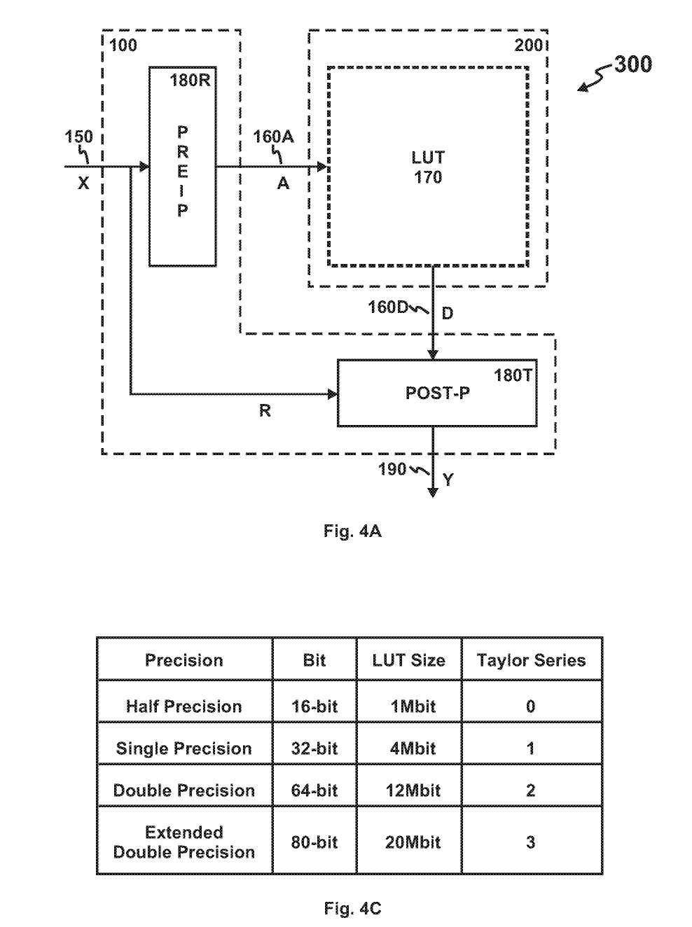

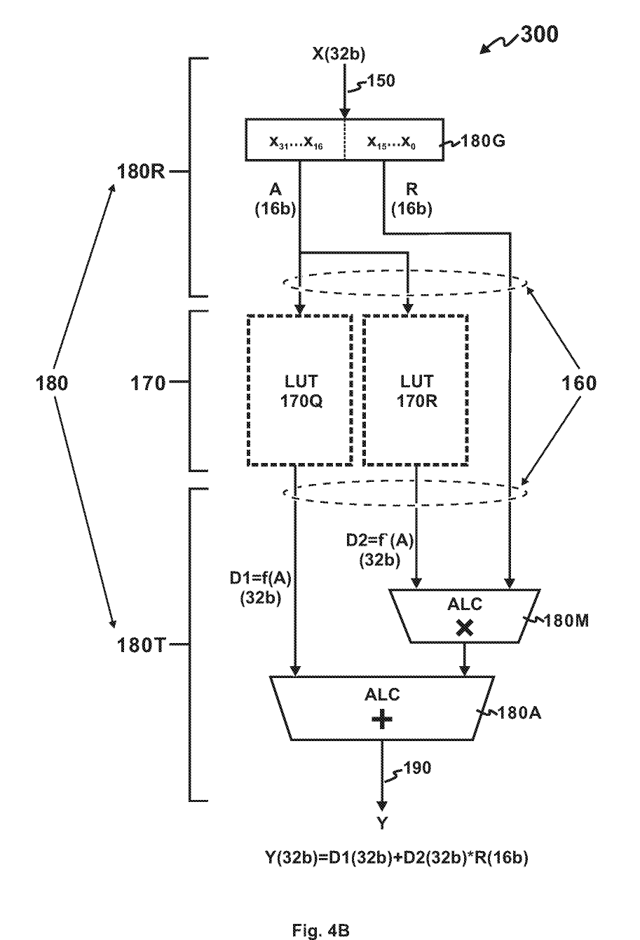

Referring now to FIGS. 4A-4C, a preferred IP-LUT processor 300 realizing a mathematical function Y=f(X) is disclosed. FIG. 4A is its simplified block diagram. Its logic die 200 comprises a pre-processing circuit 180R and a post-processing circuit 180T, whereas its memory die 100 comprises at least an IP-LUT 170 storing the function-related data. The pre-processing circuit 180R converts the input variable (X) 150 into an address (A) 160A of the IP-LUT 170. After the data (D) 160D at the address (A) is read out from the IP-LUT 170, the post-processing circuit 180T converts it into the function value (Y) 190. A residue (R) of the input variable (X) is fed into the post-processing circuit 180T to improve the calculation precision. In this preferred embodiment, the pre-processing circuit 180R and the post-processing circuit 180T are formed in the logic die 100. Alternatively, a portion of the pre-processing circuit 180R and the post-processing circuit 180T could be formed in the memory die 200.

FIG. 4B shows a preferred IP-LUT processor 300 realizing a single-precision mathematical function Y=f(X) using a function-by-LUT method. The IP-LUT 170 comprises two LUTs 170Q, 170R with 2 Mb capacity each (16-bit input and 32-bit output): the LUT 170Q stores the function value D1=f(A), while the LUT 170R stores the first-order derivative value D2=f′(A). The ALC 180 comprises a pre-processing circuit 180R (mainly comprising an address buffer) and a post-processing circuit 180T (comprising an adder 180A and a multiplier 180M). The inter-die connections 160 transfer data between the ALC 180 and the IP-LUT 170. During computation, a 32-bit input variable X (x₃₁ . . . x₀) is sent to the IP-LUT processor 300 as an input 150. The pre-processing circuit 180R extracts the higher 16 bits (x₃₁ . . . x₁₆) and sends it as a 16-bit address input A to the IP-LUT 170. The pre-processing circuit 180R further extracts the lower 16 bits (x₁₅ . . . x₀) and sends it as a 16-bit input residue R to the post-processing circuit 180T. The post-processing circuit 180T performs a polynomial interpolation to generate a 32-bit output value Y 190. In this case, the polynomial interpolation is a first-order Taylor series: Y(X)=D1+D2*R=f(A)+f′(A)*R. Apparently, a higher-order polynomial interpolation (e.g. higher-order Taylor series) can be used to improve the computation precision.

When realizing a built-in function, combining the LUT with polynomial interpolation can achieve a high precision without using an excessively large LUT. For example, if only LUT (without any polynomial interpolation) is used to realize a single-precision function (32-bit input and 32-bit output), it would have a capacity of 2³²*32=128 Gb. By including polynomial interpolation, significantly smaller LUTs can be used. In the above embodiment, a single-precision function can be realized using a total of 4 Mb LUT (2 Mb for the function values, and 2 Mb for the first-derivative values) in conjunction with a first-order Taylor series. This is significantly less than the LUT-only approach (4 Mb vs. 128 Gb).

FIG. 4C lists the LUT size and Taylor series required to realize mathematical functions with different precisions. It uses a range-reduction method taught by Harrison. For the half precision (16 bit), the required IP-LUT capacity is 2¹⁶*16=1 Mb and no Taylor series is needed; for the single precision (32 bit), the required IP-LUT capacity is 2¹⁶*32*2=4 Mb and a first-order Taylor series is needed; for the double precision (64 bit), the required IP-LUT capacity is 2¹⁶*64*3=12 Mb and a second-order Taylor series is needed; for the extended double precision (80 bit), the required IP-LUT capacity is 2¹⁶*80*4=20 Mb and a third-order Taylor series is needed. As a comparison, to realize the same double precision (64 bit), the Itanium processor needs a 22^{nd}-order Taylor series.

Besides elementary functions, the preferred embodiment of FIGS. 4A-4B can be used to implement non-elementary functions such as special functions. Special functions can be defined by means of power series, generating functions, infinite products, repeated differentiation, integral representation, differential difference, integral, and functional equations, trigonometric series, or other series in orthogonal functions. Important examples of special functions are gamma function, beta function, hyper-geometric functions, confluent hyper-geometric functions, Bessel functions, Legrendre functions, parabolic cylinder functions, integral sine, integral cosine, incomplete gamma function, incomplete beta function, probability integrals, various classes of orthogonal polynomials, elliptic functions, elliptic integrals, Lame functions, Mathieu functions, Riemann zeta function, automorphic functions, and others. The IP-LUT processor will simplify the computation of special functions and promote their applications in scientific computation.

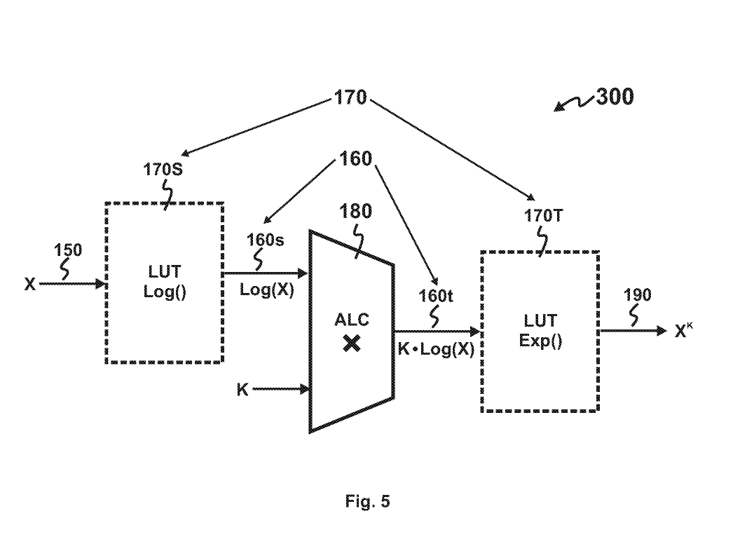

Referring now to FIG. 5, a preferred IP-LUT processor realizing a composite function using a function-by-LUT method is shown. The IP-LUT 170 comprises two LUTs 170S, 170T, which stores the function values of Log( ) and Exp( ) respectively. The ALC 180 comprises a multiplier 180M. During computation, the input variable X is used as an address 150 for the LUT 170S. The output Log(X) 160s from the LUT 170S is multiplied by an exponent parameter K at the multiplier 180M. The multiplication result K*Log(X) is used as an address 160t for the LUT 170T, whose output 190 is Y=X^{K}.

While illustrative embodiments have been shown and described, it would be apparent to those skilled in the art that many more modifications than that have been mentioned above are possible without departing from the inventive concepts set forth therein. For example, the processor could be a micro-controller, a central processing unit (CPU), a digital signal processor (DSP), a graphic processing unit (GPU), a network-security processor, an encryption/decryption processor, an encoding/decoding processor, a neural-network processor, or an artificial intelligence (AI) processor. These processors can be found in consumer electronic devices (e.g. personal computers, video game machines, smart phones) as well as engineering and scientific workstations and server machines. The invention, therefore, is not to be limited except in the spirit of the appended claims.

What is claimed is:

1. A processor for computing a mathematical function, comprising:
a memory die comprising a look-up table circuit (LUT) for storing data related to said mathematical model;
a logic die comprising an arithmetic logic circuit (ALC) for performing arithmetic operations on said data;
a plurality of inter-die connections for communicatively coupling said memory die and said logic die;
wherein said memory die and said logic die are located in a same package.

2. The processor according to claim 1, wherein said memory die and said logic die are vertically stacked.

3. The processor according to claim 1, wherein said memory die is a RAM.

4. The processor according to claim 1, wherein said memory die is a ROM.

5. The processor according to claim 1, wherein said LUT stores function values of said mathematical function.

6. The processor according to claim 1, wherein said LUT stores derivative values of said mathematical function.

7. The processor according to claim 1, wherein said mathematical function is a composite function.

8. The processor according to claim 1, wherein said mathematical function is a special function.

9. The processor according to claim 1, wherein said ALC comprises an adder.

10. The processor according to claim 1, wherein said ALC comprises a multiplier.

11. The processor according to claim 1, wherein said ALC comprises a multiply-accumulator (MAC).

12. The processor according to claim 1, wherein said ALC performs integer operations.

13. The processor according to claim 1, wherein said ALC performs fixed-point operations.

14. The processor according to claim 1, wherein said ALC performs floating-point operations.

15. The processor according to claim 1, wherein said ALC comprises a pre-processing circuit.

16. The processor according to claim 1, wherein said ALC comprises a post-processing circuit.

17. The processor according to claim 1, wherein said inter-die connections comprise micro-bumps.

18. The processor according to claim 1, wherein said inter-die connections comprise through-silicon vias (TSV).

19. The processor according to claim 1, further comprising another memory die comprising another LUT.

20. The processor according to claim 19, wherein said memory die and said another memory die are vertically stacked.
